(19) United States
(12) Patent Application Publication
(10) Pub. No.: US 2025/0066078 A1
(43) Pub. Date: Feb. 27, 2025

(54) BIODEGRADABLE NET

(71) Applicant: MAIP S.R.L., Torino (IT)

(72) Inventors: Eligio Martini, Settimo Torinese (IT); Andrea Caradonna, Settimo Torinese (IT)

(21) Appl. No.: 18/294,781

(22) PCT Filed: Aug. 2, 2022
(86) PCT No.: PCT/IB2022/057161

§ 371 Date: Feb. 2, 2024

(30) Foreign Application Priority Data
Aug. 3, 2021 (IT) 102021000020990

(51) Int. Cl. B65D 30/06; B29D 28/00; B65D 65/46

(52) U.S. Cl. CPC B65D 29/04; B29D 28/00; B65D 65/466; B65D 2565/381

(57) ABSTRACT

A biodegradable net comprising a polymeric composition comprising—a polymer selected from the group consisting of polyhydroxyalkanoate (PHA), copolymer of 1,4-butanediol, succinic acid and adipic acid (PBSA), polybutylene succinate (PBS) or mixtures thereof—at least one functional additive selected from the group consisting of Pentaerythrol tetrakis (3-(3,5-di-tert-butyl-4-hy-droxyphenyl)propionate), Octadecyl 3-(3,5-di-tert-butyl-4-hydroxyphenyl)propionate Tris (2, 4-di-tert-butylphenyl) phosphite, 1,3,5-Trimethyl-2, 4, 6-tris-(3, 5-di-tert-butyl-4-hydroxybenzyl) benzene, 2,4-Bis [(Octyl thio) methyl)]-o-cresol, 2,2′-dihydroxy-4, 4′-dimethoxy-benzophenon, Ethylene bis-(oxyethylene) his-(3-(5-tert-butyl-4-hydroxy-m-tolyl)propionate), Octadecyl-[3-(3, 5-di-tert-butyl-4-hydroxy) propionate, 2′,3-Bis[[3-[3,5-di-tert-butyl-4-hydroxyphenyl]propionyl]]propionohydrazide, Beeswax, Carnauba wax, Candelilla wax, Sumac wax (Japanese wax), Berry wax, Paraffin wax, Silicone and its derivatives, and mixtures thereof—a nucleant selected from the group consisting of Boron Nitride, Hydroxyhepatite, Zinc Stearate, Nanocrystalline Cellulose, Montmorillonite nano clay, Single wall carbon nanotube, Multi wall carbon nanotube, Cyanuric acid, Fatty acids, Fatty acid esters, Fatty acid amines, Fatty acid metal salts, pentaerythritol, di-pentaerythritol, urea derivatives, sorbitol-based compounds, sodium benzoate and mixtures thereof.

### CROSS-REFERENCE TO RELATED APPLICATIONS

This patent application claims priority from Italian Patent Application No. 102021000020990 filed on Aug. 3, 2021, the entire disclosure of which is incorporated herein by reference.

### TECHNICAL SECTOR

The present invention relates to a biodegradable net and the relative production method.

### BACKGROUND ART

Tubular and/or linear nets are known to be used in various applications such as net bags, which are obtained by a simple process of extruding and stretching the polymer into a tubular shape, followed by a process of closing one of the two ends.

In the context of the present invention, a net refers to an interweaving of bi-directional threads, interconnected by means of real or dummy knots. A dummy knot refers to a knot resulting from the partial or total fusion of two contiguous thread, while a true knot is defined as a mechanical interweaving between two threads.

The nets are applied in multiple uses with different mechanical properties that vary depending on the final application and net.

Net bags are, for example, useful for packaging fruit and vegetable items, fish items, such as mussels and clams, and recreational items, but also for protecting against hail and, in particular, all materials that end up in water or on land.

Packaging nets are also well known for protecting items contained therein, such as glass bottles, mechanical components, and electronic components, as well as in agriculture, e.g. for the protection of plants and shrubs, but also in the medical field, e.g. to protect injuries and as an elastic containment band.

Tubular nets may also be cut and used as linear nets in fences to protect animals and plants.

A common feature of nets is that they must have high mechanical properties in order to properly “contain” goods or fulfil their functions in various applications.

In the context of the present invention, a net refers to an interweaving of more or less densely meshed threads with or without knots at the points where the threads meet.

However, nets are a major polluting source and a source of microplastics that pollute the seas, and so research is being carried on for nets that maintain the mechanical characteristics of the known ones, but that are entirely biodegradable and therefore non-polluting. Such a balance is particularly complex in that the nets are spun by extrusion and must maintain a given elasticity, and the threads constituting the nets are of such a size that their tensile strength is particularly complex.

Several attempts have been made in the past to obtain biodegradable nets, but maintaining the mechanical characteristics generally requires the addition of a number of additives that compromise the biodegradability characteristics thereof and vice versa.

To date, therefore, a correct balance of compounds making it possible to produce nets fully biodegradable in 90 days has not yet been found.

### SUMMARY OF THE INVENTION

The aim of the invention is a biodegradable net with high mechanical properties that overcomes the above-described problems and, in particular, allows it to be used as packaging for fruit and fish products, as a protective net in agriculture and in all other uses where nets are used.

A further aim of the present invention is a method for producing a biodegradable net.

Such aims are achieved by the present invention as it relates to a polymeric composition according to Claim 1 and a method according to Claim 8.

### BRIEF DESCRIPTION OF THE DRAWINGS

FIG. 1 shows Table 1 with 9 examples of composition according to the present invention; and

FIG. 2 shows a set of biodegradability tests performed on different net samples according to the present invention.

### DESCRIPTION OF THE INVENTION

In the context of the present invention, a polymeric material refers to a polymer-based material, whether polymers derived from a single monomer or copolymers or mixtures of several polymers, even having different characteristics.

In the context of the present invention, a polymeric composition refers to a composition comprising at least one polymer and any other additives, such as plasticizers, compatibilizers, etcetera.

Hereinafter, the short designations of polymers will often be used in accordance with the official IUPAC nomenclature, e.g. DIN EN ISO 1043-1, DIN ISO 1629 and DIN ISO 2076.

PHA or PHA-based polymers refer, in the context of the present invention, to a polymer containing repeating units of formula:

—O—CHRi-(CH2)n-CO— (I)
where:
Ri is selected from —H, alkyls C1-C12, cycloalkyls C-C16, alkenyls C2-C12, optionally replaced with at least one group selected from: halogen (F, Cl, Br), —CN, —OH, —COOH, —OR, —COOR (R=C1-C4 alkyl, benzyl); n is zero or an integer between 1 and 6, preferably 1 or 2.

Preferably, Ri is methyl or ethyl, and n is 1 or 2.

PHAs may be both homopolymers or copolymers or terpolymers. In the case of copolymers or terpolymers, the PHA may consist of several repeating units of formula (I), or at least one repeating unit of formula (I) in combination with at least one repeating unit deriving from comonomers capable of copolymerising with hydroxyalkanoates, such as lactones or lactams.

In the latter case, the repeating units of formula (I) are present in an amount equal to at least 10 mol/% with respect to the total number of repeating units.

Particularly preferred repeating units of formula (I) are those deriving from: 3-hydroxybutyrate, 3-hydroxyvalerate, 3-hydroxyhexanoate, 3-hydroxyoctanoate, 3-hydroxyundec-10-enoate, 4-hydroxyvalerate.

Particularly preferred PHAs are: poly-3-hydroxybutyrate (PHB), poly-3-hydroxyvalerate (PHV), poly-3-hydroxyhexanate (PHH), poly-3-hydroxyoctanoate (PHO), poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate), poly(3-hydroxyoctanoate-co-3-hydroxyundecen-10-enoate) (PHOU), poly(3-hydroxybutyrate-co-3-hydroxyvalerate-co-4-hydroxyvalerate) (PHBW), or mixtures thereof.

Even more preferred are PHB and PHBH.

Hereinafter, and particularly in the examples in Table 1, a mixture of PHA refers to a mixture of PHB and PHBH.

Preferably, the PHA of a preferred embodiment has a weight average molecular weight (M) that can range from 10,000 to 1,000,000.

PHA is preferably produced by microbial fermentation of an organic substrate, e.g. carbohydrates or other fermentable substrates such as glycerol, through a strain of micro-organisms capable of producing PHA, and subsequent recovery of PHA from the cell mass. Substrates suitable for producing PHAs by fermentation may be obtained in particular from the processing of plants, for example juices, molasses, pulps from the processing of sugar beet, sugar cane. These substrates generally contain, in addition to sucrose and other carbohydrates, organic growth factors, nitrogen, phosphorus and/or other minerals which are useful as nutrients for cell growth. An alternative is glycerol, a cheap source of organic carbon, being a by-product of biodiesel production, which can optionally be used in a mixture with levulinic acid.

PBSA refers to a copolymer of 1,4-butanediol, succinic acid and adipic acid. PBSA is prepared by adding adipic acid to the starting materials during PBS synthesis. Although usually synthesised from fossil fuels, it is also possible that the monomers that make up PBSA are produced from bio-based raw materials. PBSA degrades faster than PBS, but PBS and PBSA biodegrade more slowly than PHAs.

PBS refers to a polybutylene succinate polymer preferably semi-crystalline and preferably manufactured by bacterial fermentation.

According to a preferred embodiment, the biodegradable net comprises a polymer composition comprising at least one polymer selected from the group consisting of: polymers based on polyhydroxyalkanoate (PHA), copolymer of 1,4-butanediol, succinic acid and adipic acid (PBSA) or polybutylene succinate (PBS).

Hereinafter, when percentages are indicated, they refer to percentages by weight with respect to the total weight of the composition.

According to an even more preferred embodiment, the biodegradable net comprises at least 80% by weight of a polymer composition of one or more polymers selected from the group consisting of: polymers based on polyhydroxyalkanoate (PHA), copolymer of 1,4-butanediol, succinic acid and adipic acid (PBSA) or polybutylene succinate (PBS) jointly with one or more additives.

According to an even more preferred embodiment, the biodegradable net consists of a polymeric composition of one or more polymers selected from the group consisting of: polymers based on polyhydroxyalkanoate (PHA), copolymer of 1,4-butanediol, succinic acid and adipic acid (PBSA) or polybutylene succinate (PBS) jointly with one or more additives.

Additives refer to substances that improve some of the mechanical or chemical characteristics of the composition.

Among PHAs, polyhydroxybutyrate (PHB) is preferred, even more preferably a mixture of PHB and poly(3-hydroxybutyrate-co-3-hydroxyhexanoate) (PHBH) is used.

Process additives and stabilizers are added to the polymeric composition.

Preferably a mixture of PHA and PBSA is used, and even more preferably in this case PBSA is added in an amount of 0.06% to 49% by weight.

Preferably, the polymeric composition does not comprise PLA or polylactic acid.

Preferably, the polymeric composition is added in an amount of 50.00% to 99.95% by weight relative to the total weight of all the net components.

Preferably, a plasticizer is also added to the polymeric composition. Preferably, the plasticizer is selected from the group called group A and consists of poly(ethylene glycol) (PEG), acetyl-tri-n-butyl citrate (ATBC), isosorbide diester (ISE), sorbitol, glycerol, acetylated monoglycerides, epoxidised soybean oil (ESBO), triethyl citrate (TEC), tri (ethylene glycol) bis(2-ethyl hexanoate) (TEG-EH), tributyl citrate (TBC), 1,3,2,4-dibenzylidene sorbitol, 1,3-p-methylbenzylidene-2,4-benzylidene sorbitol, bis(stearylureide) hexane, 1,3,2,4-di(p-methylbenzylidene) sorbitol, 1,3,2,4-dibenzylidene sorbitol and mixtures thereof.

More preferably, the plasticizer is optional in the formulation and depends on the flexibility required to the net.

Preferably, the plasticizer is added in an amount of 0 to 50% by weight. More preferably between 5 and 30% by weight, even more preferably between 0 and 10% by weight.

In a preferred embodiment, at least one nucleant is also added. Preferably the nucleant is selected from the group called group B and consists of Boron nitride, Hydroxyhepatite, Zinc stearate, Nanocrystalline cellulose, Montmorillonite nano clay, Single wall carbon nanotube, Multi wall carbon nanotube, Cyanuric acid, Fatty acids, Fatty acid esters, Fatty acid amines, Metal salts of fatty acids, Pentaerythritol, Di-pentaerythritol, Urea derivatives, Sorbitol compounds, Sodium benzoate and mixtures thereof.

Preferably the nucleant is selected from the group consisting of Boron nitride, Montmorillonite nano clay, pentaerythritol, di-pentaerythritol.

Preferably, the nucleant is added in a percentage by weight ranging from 0.05 to 1.5 by weight, more preferably between 0.05 and 1%, e.g. 0.5% by weight.

Preferably, a functional additive is also added to the production process.

A functional additive refers to an additive that allows the net to be given a certain characteristic such as flexibility.

The functional additive is preferably selected from the group called group C and consists of Pentaerythrol tetrakis(3-(3,5-di-tert-butyl-4-hydroxyphenyl)propionate), Octadecyl 3-(3,5-di-tert-butyl-4-hydroxyphenyl)propionate Tris(2,4-di-tert-butylphenyl)phosphite, 1,3,5-Trimethyl-2,4,6-tris-(3,5-di-tert-butyl-4-hydroxybenzyl)benzene, 2,4-Bis[(Octylthio)methyl)]-o-cresol, 2,2′-dihydroxy-4,4′-dimethoxy-benzophenon, Ethylene bis(oxyethylene) bis-(3-(5-tert-butyl-4-hydroxy-m-tolyl)propionate), Octadecyl-[3-(3,5-di-tert-butyl-4-hydroxyphenyl)propionate, 2′,3-Bis[[3-[3,5-di-tert-butyl-4-hydroxyphenyl]propionyl]]propionohydrazide, wax, in particular Beeswax, Carnauba wax, Candelilla wax, Sumac wax (Japanese wax), Berry wax, Paraffin, Silicone and its derivatives, and mixtures thereof.

More preferably, the functional additive is selected from the group consisting of Beeswax, Carnauba Wax, Candelilla Wax, Sumac Wax (Japanese Wax) which have made it possible to obtain particularly useful results in the nets.

Each functional additive is preferably added in a percentage by weight ranging from 0.05 to 5%, more preferably between 0.05 and 1% by weight.

In addition, at least one viscosity modifier and/or a compatibilizer is added, such as at least one of the substances selected from group D consisting of: DCP or dicumyl peroxide, TBPB or of tert. Butylperoxybenzoate, Hexamethylene diisocyanate (HMDI), Multifunctionalized styrene-co-glycidyl methacrylate oligomer (Joncryl®), Triglycidyl isocyanurate (TGIC), Benzoyl peroxide (BPO), Methylene diphenyl diisocyanate (MDI).

More preferably, the viscosity modifier and/or compatibilizer is selected from the group consisting of dicumyl peroxide, TBPB of tert. Butylperoxybenzoate, multifunctionalized styrene-co-glycidyl methacrylate oligomer (Joncryl®) and mixtures thereof.

Even more preferably, the viscosity modifier and/or compatibilizer is selected from the group consisting of dicumyl peroxide (DCP), multifunctionalized styrene-co-glycidyl methacrylate oligomer (Joncryl®) and mixtures thereof.

Viscosity modifiers and compatibilizers are preferably added in a percentage by weight between 0.001 and 1% individually and overall between 0.05 and 2% by weight.

Additional materials such as dyes or perfumes can also be added to form nets for specific applications.

The process for producing a tubular, or planar net, made of bio-based and biodegradable plastic material preferably involves the following steps:

Optionally, polyhydroxyalkanoate (PHA) is mixed with at least a second polymeric material to form a basic polymeric compound. If no mixing is performed, the basic polymeric compound consists of only one or more of the above-mentioned polymers among PHA, PBS and PBSA.

Additional additives such as compatibilizers are also added in this step.

Next, plasticizers are preferably added, in a ratio of 0-50% by weight of the basic polymeric compound.

The polymeric compound is then melted in a first extrusion step. The first extrusion step preferably takes place in a screw extruder.

The melt is then processed in a granulation system to obtain granules.

The granules are then dried. Drying takes place preferably at temperatures between 60-70° C. and preferably for 2-6 hours.

The dried granules are extruded in a second extrusion step to form a tubular net. The second extrusion step preferably takes place in a rotary head extruder capable of forming a tubular net. The tubular net is preferably formed by simple rotating the extruder head.

Optionally, the second extrusion step is followed by a stretching step.

In order to form a planar net, an additional mechanical cutting step must be performed longitudinally to one of the walls of the tubular net formed, which is generally performed during the step of forming the tubular net.

The invention will be described hereinafter by means of examples although it is not limited thereto.

### Examples 1-9

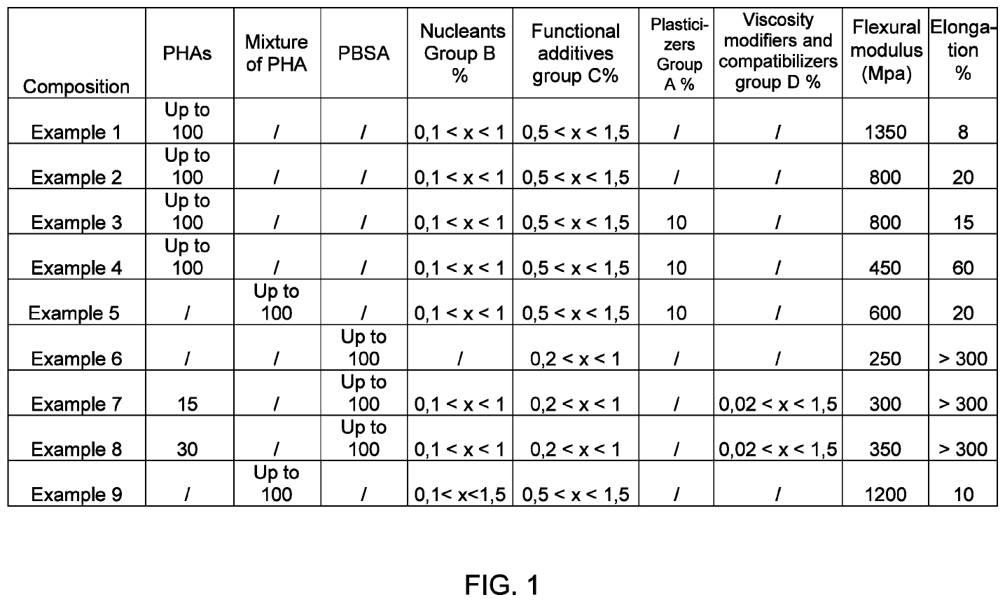

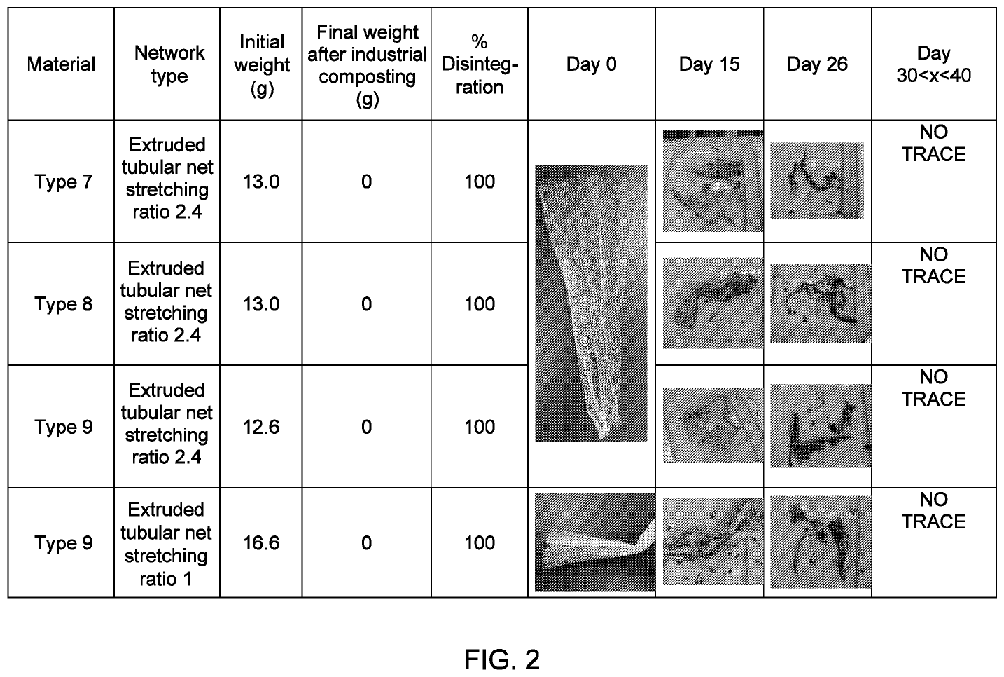

Table 1 in FIG. 1 shows 9 different compositions according to the present invention with their most relevant mechanical properties for making nets, i.e. elongation and flexural modulus. It can easily be observed that the use of selection of materials according to the present invention allows the chemical components to be properly modulated according to the desired mechanical properties while maintaining a high degree of biodegradability as confirmed by the samples tested in FIG. 2.

1. A biodegradable net comprising a polymeric composition comprising:
a polymer selected from the group consisting of polyhydroxyalkanoate (PHA), copolymer of 1,4-butanediol, succinic acid and adipic acid (PBSA), polybutylene succinate (PBS) and mixtures thereof;
at least one functional additive selected from the group consisting of Pentaerythrol tetrakis(3-(3,5-di-tert-butyl-4-hydroxyphenyl)propionate), Octadecyl 3-(3,5-di-tert-butyl-4-hydroxyphenyl)propionate Tris(2,4-di-tert-butylphenyl)phosphite, 1,3,5-Trimethyl-2,4,6-tris-(3,5-di-tert-butyl-4-hydroxybenzyl)benzene, 2,4-Bis[(Octylthio)methyl)]-o-cresol, 2,2′-dihydroxy-4,4′-dimethoxy-benzophenon, Ethylene bis-(oxyethylene) bis-(3-(5-tert-butyl-4-hydroxy-m-tolyl)propionate), Octadecyl-[3-(3,5-di-tert-butyl-4-hydroxy)propionate, 2′,3-Bis[[3-[3,5-di-tert-butyl-4-hydroxyphenyl]propionyl]]propionohydrazide, Beeswax, Carnauba wax, Candelilla wax, Sumac wax (Japanese wax), Berry wax, Paraffin wax, Silicone and its derivatives, and mixtures thereof; and
a nucleant selected from the group consisting of Boron Nitride, Hydroxyhepatite, Zinc Stearate, Nanocrystalline Cellulose, Montmorillonite nano clay, Single wall carbon nanotube, Multi wall carbon nanotube, Cyanuric acid, Fatty acids, Fatty acid esters, Fatty acid amines, Fatty acid metal salts, pentaerythritol, di-pentaerythritol, urea derivatives, sorbitol-based compounds, sodium benzoate and mixtures thereof.

2. The biodegradable net according to claim 1, wherein the polymer comprises at least the copolymer of 1,4-butanediol, succinic acid and adipic acid (PBSA) and polyhydroxyalkanoate (PHA).

3. The biodegradable net according to claim 1, wherein the polymer comprises polyhydroxyalkanoate (PHA) and said polyhydroxyalkanoate (PHA) is present in an amount by weight relative to the amount of total polymers in the polymeric composition between 10 and 90%.

4. The biodegradable net according to claim 1, further at least one plasticizer selected from the group consisting of poly(ethylene glycol) (PEG), acetyl-tri-n-butyl citrate (ATBC), isosorbide diester (ISE), sorbitol, glycerol, Acetylated monoglycerides, Epoxidized soybean oil (ESBO), Triethyl citrate (TEC), tri (ethylene glycol) bis(2-ethyl hexanoate) (TEG-EH), Tributyl citrate (TBC), 1,3,2,4-dibenzylidene sorbitol, 1,3-p-methylbenzylidene-2,4-benzylidenesorbitol, bis (stearylureide) hexane, 1,3,2,4-di (p-methylbenzylidene) sorbitol, 1,3,2,4-dibenzylidenesorbitol, and mixtures thereof.

5. The biodegradable net according to claim 1, comprising at least 80% by weight of the total weight of the net, the polymer selected from the group consisting of polyhydroxyalkanoate (PHA), copolymer of 1,4-butanediol, succinic acid and adipic acid (PBSA), polybutylene succinate (PBS) or mixtures thereof.

6. The biodegradable net according to claim 1, wherein the nucleant is selected from the group consisting of Boron Nitride, Montmorillonite Nano Clay, pentaerythritol, and di-pentaerythritol.

7. The biodegradable net according to claim 1, wherein the at least one functional additive is selected from the group consisting of Beeswax, Carnauba Wax, Candelilla Wax, Sumac Wax (Japanese wax).

8. The biodegradable net according to claim 1, further comprising at least one viscosity modifier and/or one compatibilizer selected from the group consisting of DCP dicumyl peroxide, TBPB of tert. Butylperoxybenzoate, Hexamethylene diisocyanate (HMDI), Multifunctionalized styrene-co-glycidyl methacrylate oligomer (Joncryl®), Triglycidyl isocyanurate (TGIC), Benzoyl peroxide (BPO), and Methylene diphenyl diisocyanate (MDI).

9. The biodegradable net according to claim 1, further comprising a viscosity modifier and/or a compatibilizer selected from the group consisting of dicumyl peroxide, TBPB of tert. Butylperoxybenzoate, multifunctionalized styrene-co-glycidyl methacrylate oligomer (Joncryl®) and mixtures thereof.

10. The biodegradable net according to claim 1, wherein the Polymeric composition does not comprise PLA (polylactide acid).

11. A process for making a biodegradable net according to claim 1, comprising:
forming a polymeric compound comprising a polymer selected from the group consisting of polyhydroxyalkanoate (PHA), copolymer of 1,4-butanediol, succinic acid and adipic acid (PBSA), polybutylene succinate (PBS) or mixtures thereof-;
melting the polymer compound in a first extrusion step;
forming granules from the melted material;
drying the granules; and
forming a tubular net in a second extrusion step.

12. The process for making a biodegradable net according to claim 11, wherein the first extrusion step takes place using a screw extruder.

13. The process for making a biodegradable net according to claim 11, further comprising adding a plasticizer in an amount of between 1 and 50% by weight to the total weight of the polymeric compound.

14. The process for making a biodegradable net according to claim 11, wherein said second extrusion step takes place using a rotary head extruder.

15. (canceled)

16. A method, comprising using the biodegradable net according to claim 1 for packaging or as a medical or agricultural containment net.
